(19) United States
(12) Patent Application Publication
(10) Pub. No.: US 2001/0035508 A1
(43) Pub. Date: Nov. 1, 2001

(54) Return spring and adjusting mechanism for an automotive throttle body

(76) Inventor: Zhouxuan Xia, Windsor (CA)

Correspondence Address: Elsa Keller, Siemens Corporation, 186 Wood Avenue South, Iselin, NJ, 08830, US

(21) Appl. No.: 09/821,295

(22) Filed: Mar. 29, 2001

Related U.S. Application Data
(60) Provisional application No. 60/198,076, filed on Apr. 17, 2000.

(51) Int. Cl. F16K 1/22; F16K 31/04

(52) U.S. Cl. 251/69; 251/129.12

(57) ABSTRACT

The subject invention is a throttle return mechanism for an electronically controlled throttle that provides for the precise setting of a limp home throttle blade position. The throttle return mechanism includes a return spring with two legs attached to a fixed shaft, and a bracket attached to a drive mechanism. The bracket includes stops that engage the return spring as the bracket rotates about the fixed shaft. Each stop is cam shaped and rotatable to provide for adjustment of the limp home throttle blade setting. When the drive mechanism is disabled the legs of the return spring will engage the stops on the bracket and rotate the throttle blade to the limp home position. The second leg of the return spring will rotate and hold the throttle valve in a limp home throttle position to allow a driver to maneuver the motor vehicle.

This application claims priority to provisional application Ser. No. 60/198,076 filed on Apr. 17, 2000.

### BACKGROUND OF THE INVENTION

This application discloses an improved limp home feature for an electronic throttle control. An electronic throttle control (ETC) replaces a mechanical throttle linkage to control opening of the throttle. The throttle is actuated by a motor controlled by the ETC and opens proportionally relative to signals received from a sensor placed on an accelerator pedal. A typical ETC includes a throttle body having a bore to intake air and a throttle disposed within the bore to regulate the intake of air between an open and closed position.

As appreciated, if the motor of the ETC becomes disabled, the throttle will be inoperable. When the ETC is disabled the throttle is preferably moved to a default limp home throttle position. The limp home throttle position provides an engine speed that will produce enough power that can easily be controlled by a driver. The intent of the limp home position is to provide the driver with sufficient power to maneuver the vehicle. Typically, the throttle is moved to the limp home position by some type of spring attached to the throttle blade. The spring must be able to maintain the throttle position in the limp home throttle position against vacuum forces created by the flow of air into the engine of the motor vehicle. The variability of springs used for limp home applications may create variations in limp home throttle positions that cause undesirable variation in the engine speed at the limp home throttle position.

The engine speed required for the limp home throttle setting must be set precisely, because a limp home engine speed that is too low will not provide the necessary engine power to maneuver the vehicle. Alternatively, too high an engine speed may create a sensation in the driver of being out of control of the vehicle. For these reasons it is desirable and necessary to provide a mechanism that provides for the precise reliable setting of the limp home throttle position.

### SUMMARY OF THE INVENTION

The subject invention is a throttle return mechanism for an electronic throttle control that returns a throttle blade from an open position to a limp home position when the electronic throttle control is disabled. The subject invention is an electronically controlled throttle valve for a motor vehicle including a throttle body having an air flow passage defining a longitudinal axis and an axis of rotation transverse to the longitudinal axis. A throttle blade having a central bore is supported for rotation about the axis of rotation between a fully open position and a fully closed position. A drive mechanism drives the throttle blade between the fully open position and the fully closed position. The return mechanism includes a return spring attached to a fixed shaft and a bracket that is attached to the drive mechanism. The bracket rotates with the drive mechanism and thereby the throttle blade. The shaft remains fixed and does not rotate relative to the throttle body. The return spring includes a first leg and a second leg. Each of the legs engages a stop mounted to the bracket.

During normal operation the motor overcomes the force of the return spring to position the throttle blade. When the motor is disabled, the first leg of the return spring will engage the first stop and rotate the throttle blade toward the closed position. The second leg of the return spring will rotate the throttle blade to the limp home position. The throttle blade is balanced between the legs of the return spring to maintain the throttle blade in the limp home position. The stops are cam shaped and rotatable about pins on the bracket. Each pin includes a plurality of interconnecting teeth that prevent rotation of the stop relative to the bracket and provide for precise adjustment of the limp home throttle blade position.

The subject invention provides a simple, precise, compact and cost effective assembly to adjust the limp home throttle blade position.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a cross-sectional view of a throttle body having the drive mechanism disposed within a throttle blade;

FIG. 2A is a schematic view illustrating the fully open throttle blade position;

FIG. 2B is a schematic view illustrating the fully closed throttle blade position;

FIG. 2C is a schematic view illustrating the limp home throttle blade position;

FIG. 3 is a perspective view of the return spring mechanism attached to the drive mechanism; and

FIG. 4 is an exploded view of the return mechanism.

### DETAILED DESCRIPTION OF THE PREFERRED EMBODIMENT

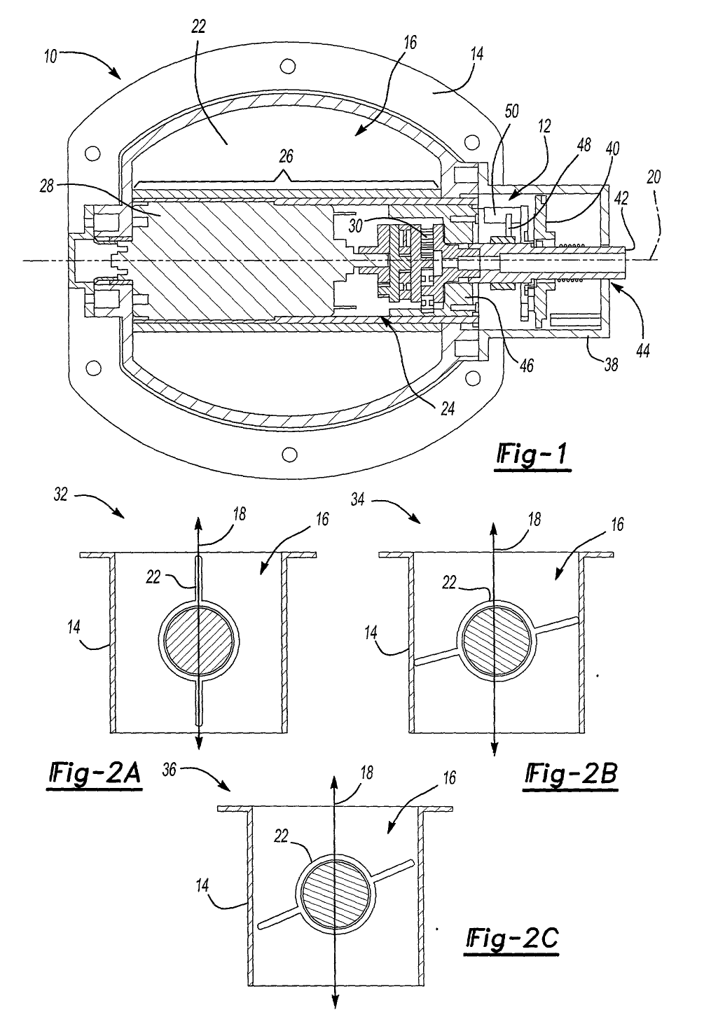

Referring to the Figures, wherein like numerals indicate like or corresponding parts throughout the several views, where the subject invention is a return mechanism 12 for an electronically controlled throttle valve 10. Referring to FIG. 1, the electronically controlled throttle valve 10 includes a throttle body 14 with an air flow passage 16 defining a longitudinal axis 18 (shown in FIGS. 2A, 2B, and 2C) and an axis of rotation 20 that is transverse to the longitudinal axis 18. A throttle blade 22 is supported within the air passage 16 for rotation about the axis 20.

In the preferred embodiment, the throttle blade 22 includes a central bore 24. A drive mechanism 26 is at least partially disposed within the central bore 24 of the throttle blade 22. The drive mechanism 26 includes a motor 28 connected to a set of drive gears 30. The drive gears 30 driven by the motor 28 act to rotate the throttle blade 22 between a fully open throttle blade position 32 (shown in FIG. 2A) and a fully closed throttle blade position 34 (shown in FIG. 2B). It should be understood that the drive mechanism 26 shown and described is only one type that maybe utilized with this invention. A worker knowledgeable will recognize that the subject invention may be practiced with any type of drive mechanism known in the art.

When the drive mechanism 26 becomes disabled for any reason the return mechanism 12 will rotate the throttle blade 22 to a partially open position shown in FIG. 2C. This is known as a limp home throttle blade position 36. The limp home throttle blade position 36 provides an engine speed that supplies enough power for the motor vehicle to be driven home. The specific limp home throttle position is adjusted to provide enough power to maneuver the motor vehicle home or to a service station, while limiting power such that a driver can maintain control of the motor vehicle.

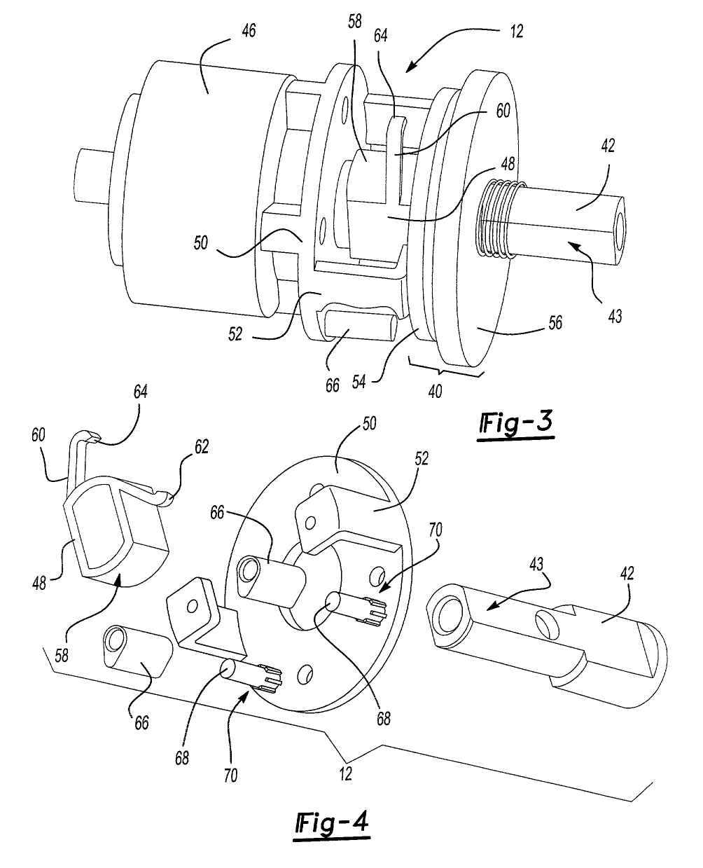

Referring back to FIG. 1, a housing 38 secured to one side of the throttle body 14 encloses a throttle position sensor 40 and the return mechanism 12. A shaft 42 extends from the drive mechanism 26 through an opening 44 in the housing 38. As shown in FIG. 4, the shaft has a flat surface 43 that cooperates with the opening 44 in the housing to prevent any rotation relative to the throttle body 14. The shaft 42 does not rotate along with the drive mechanism 26 or the throttle blade 22. Referring now to FIG. 3, the return mechanism 12 is shown attached to a portion of the drive mechanism 46. A return spring 48 is fixed to the shaft 42 and does not rotate with the drive mechanism 26 or the throttle blade 22. A bracket 50 is attached to the drive mechanism 26 to rotate along with the drive mechanism 26 and thereby the throttle blade 22. The bracket 50 rotates about the shaft 42 and the return spring 48.

The bracket 50 includes arms 52 for mounting the throttle position sensor 40 that monitors throttle blade position. The throttle position sensor 40 in the preferred embodiment has wiper plate 54 that is attached to the arms 52 of the bracket 50. The wiper plate 54 rotates with the bracket 50 and thereby send the position signal to a computer, control devce 3 to activate the drive mechanism 26 and the throttle blade 22. A stationary plate 56 is attached to the shaft 42. Rotation of the wiper plate 54 relative to the stationary plate 56 is monitored to provide the position of the throttle blade 22. It should be understood that any throttle position sensor known to one knowledgeable in the art may be used and that the embodiment described and shown is only one of many possible configurations.

The return spring 48 includes a collar 58 that attaches to the shaft 42 and first and second legs 60, 62 extending from the collar 58. The distal end of each leg is bent into a hook shape 64. Each of the legs 60,62 of the return spring 48 engages a stop 66 that is mounted to the bracket 50. Referring to FIG. 4, the bracket 50 includes two mounting pins 68. A stop 66 is mounted over each pin 68. The stops 66 are cam shaped to provide for precise adjustment of the limp home throttle blade position 36. The adjustment is accomplished by rotating the cam shaped stop 66 until the desired throttle blade position is attained. Each pin 68 includes a plurality of teeth 70 that matingly engage teeth disposed within each stop 66.

In operation, the throttle blade 22 is driven by the drive mechanism 26 about the axis 20 and will overcome the force exerted by the return spring 48 to move the throttle blade 22 to the desired position. When the drive mechanism 26 is disabled the return spring 48 will rotate the throttle blade 22 to the limp home position 36. The first leg 60 engages one of the stops 66 to rotate the throttle blade 22 toward the closed position 34 and the second leg 62 will hold the throttle blade 22 open in the limp home position 36. The legs 60,62 of the return spring 48 are balanced against one another to hold the throttle blade 22 in the proper limp home position 36. Further, the legs 60,62 of the return spring 48 must counteract a vacuum force created by the air drawn into the engine of the motor vehicle that creates a vacuum force that tends to pull the throttle blade 22 to the closed position 34. The return spring 48 provides a sufficient force to counter act the vacuum force and hold the throttle blade 22 in the limp home position.

In order to precisely set the limp home position 36, the cam shaped stops 66 are lifted off the pins 68 to clear the mating teeth 70, then rotated into position and replaced onto the mating teeth 70. In this way the precise limp home position 36 for the throttle blade 22 can be accurately set for each specific motor vehicle.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. An electronically controlled throttle valve for a motor vehicle comprising:
a throttle body having an air flow passage defining a longitudinal axis and an axis of rotation that is transverse to said longitudinal axis;
a throttle blade disposed within said air flow passage;
a drive mechanism to rotate said throttle blade about said transverse axis between a fully open position and a fully closed position;
a bracket attached to said drive mechanism;
a shaft fixed to said throttle body such that there is no relative movement between said throttle body and said shaft;
a return spring attached to said fixed shaft and in contact with said bracket to rotate said drive mechanism and said throttle blade to a limp home position when said drive mechanism is disabled.

2. The assembly of claim 1, wherein said bracket fixed to said drive mechanism includes at least one stop that operates to engage said return spring.

3. The assembly of claim 2, wherein said return spring includes a first leg and a second leg, said first leg engages a first stop of said bracket to rotate said throttle blade from said fully open position toward said fully closed position and said second leg engages a second stop to rotate said throttle blade to said limp home position.

4. The assembly of claim 3, wherein a hook is disposed at a distal end of said first and second legs of said return springs.

5. The assembly of claim 1, wherein said return spring is fixed to said shaft such that said return spring remains fixed and said bracket rotates about said transverse axis relative to said return spring.

6. The assembly of claim 3, wherein said first and second stops are cam shaped and rotatable relative to said bracket for adjustment of said limp home position.

7. The assembly of claim 7, wherein said bracket includes a first pin and a second pin, and said first and second stops are secured to said pins.

8. The assembly of claim 8, wherein said first and second stops are secured in a specific position about said pin by a plurality of interconnecting notches disposed on said stops and said pins.

9. The assembly of claim 2, wherein said bracket further includes arms for securing a position sensor to monitor the position of the throttle blade relative to the throttle body.

10. An electronically controlled throttle valve for a motor vehicle comprising:
a throttle body having an air flow passage defining a longitudinal axis and an axis of rotation that is transverse to said longitudinal axis;
a throttle blade supported for rotation about said axis of rotation between a fully open position and a filly closed position, said throttle blade having a central bore;
a drive mechanism at least partially enclosed within said central bore of said throttle blade to move said throttle blade between said fully open position and said fully closed position; and
a return spring attached to rotate said throttle blade to a limp home position when said drive mechanism is disabled.

11. The assembly of claim 11, further including a shaft secured to said throttle body such that there is no relative rotation between said throttle body and said shaft, and said return spring is secured to said shaft.

12. The assembly of claim 12, further including a bracket secured to said drive mechanism, said bracket having first and second stops that operate to engage said return spring upon rotation of said bracket and said drive mechanism about said transverse axis.

13. The assembly of claim 13, wherein said return spring includes first and second legs, and said legs extend from a collar, said collar secures said return spring to said shaft.

14. The assembly of claim 14, wherein said first leg on said return spring engages said first stop to return said throttle blade substantially to said closed position, and said second leg engages said second stop to open said throttle blade to said limp home position.

15. The assembly of claim 13, wherein said first and second stops are cam shaped and rotatable relative to said bracket for adjustment of said limp home position.

16. The assembly of claim 16, wherein said bracket includes first and second pins, and said first and second stops are secured to, and prevented from rotating about said pins by a plurality of interconnecting notches disposed on said stops and said pins.

17. The assembly of claim 13, wherein said bracket includes arms to which a throttle position sensor is mounted for monitoring the position of the throttle blade relative to the throttle body.
